(19) United States
(12) Patent Application Publication
(10) Pub. No.: US 2023/0402055 A1
(43) Pub. Date: Dec. 14, 2023

(54) SYSTEM AND METHOD FOR MATCHING A VISUAL SOURCE WITH A SOUND SIGNAL

(71) Applicant: Samsung Electronics Co., Ltd., Suwon-si (KR)

(72) Inventors: Sathyanarayanan KULASEKARAN, Bengaluru (IN); Sarthak SENGUPTA, Bengaluru (IN); Sujoy SAHA, Bengaluru (IN)

(21) Appl. No.: 18/163,618

(22) Filed: Feb. 2, 2023

Related U.S. Application Data
(63) Continuation of application No. PCT/KR2023/000402, filed on Jan. 9, 2023.

(30) Foreign Application Priority Data
Jun. 8, 2022 (IN) 202241032827
Nov. 24, 2022 (IN) 2022 41032827

(51) Int. Cl. G10L 25/51; G10L 25/30; G10L 21/10

(52) U.S. Cl. CPC G10L 25/51; G10L 25/30; G10L 21/10

(57) ABSTRACT

A method for matching a visual source with a respective sound signal is provided. The method includes receiving a real-world sound input including a combination of one or more sound signals originating from a plurality of sound-generating objects, separating one or more sound signals from the real-world sound input, detecting sound generating objects included in the visual source, generating an association between each of the sound generating objects and the one or more separated sound signals, and matching, in real-time, each of the detected sound generating objects with respective sound signals from the one or more separated sound signals based on the association.

### CROSS-REFERENCE TO RELATED APPLICATION(S)

This application is a continuation application, claiming priority under § 365(c), of an International application No. PCT/KR2023/000402, filed on Jan. 9, 2023, which is based on and claims the benefit of an Indian Provisional patent application number 202241032827, filed on Jun. 8, 2022, in the Indian Patent Office, and of an Indian Complete patent application number 202241032827, filed on Nov. 24, 2022, in the Indian Patent Office, the disclosure of each of which is incorporated by reference herein in its entirety.

### TECHNICAL FIELD

The disclosure relates to a field of sound source separation. More particularly, the disclosure relates to a method and system for training sound source separation using Convolution Interpretation Maps and Visual Objects Mapping.

### BACKGROUND ART

Traditionally, where a user is standing on a street corner in a city, with eyes closed, the user may hear and recognize a variety of sounds such as people walking, cars honking, people speaking, raining, etc. It is a trivial task for humans (such as the user) to recognize the multiple sound sources. This is a result of years of natural training, the mind of the user has registered a variety of sounds from various sources. However, it has been difficult for devices/machines to handle the learning of multiple sound sources and separate the sound received from multiple sources.

In recent years, rapid progress has been made on single-channel sound separation techniques using supervised training of deep neural networks.

In a supervised training setting, there is an input label and an output label (such as Ground Truth). The ground truth is a reference output that the system or the machine learning model is trained to learn in order to reproduce when given an input. Currently existing sound source separation methods with supervised approach use ground truth as a source waveform, i.e., a sound clip in its purest form (without any mixing). Mixing multiple such source waveforms produce the input waveform. Hence, the input is a mixed signal, because it is synthetically mixed by using sound clips from multiple isolated sources. This has been a practically feasible approach but is problematic since the mixed signal might not be close to the real-world mixed signal where the sound sources naturally overlap each other when a single channel is used to capture the sound. This tends to deteriorate the model performance when used for separation in real world, since the training data is synthetic and is far from the real-world data.

For instance, the user may attend a meeting from a coffee shop through a video call. In the coffee shop, there may be multiple audios coming from different sources such as coffee machine, people talking, music etc. The user may prefer to increase the audio of just his voice and may desire to suppress the other extra sounds. The existing techniques may not disclose the deep neural networks for separating sounds from multiple sources and process to train the deep neural network using real-world sounds.

The existing techniques may use source waveforms (before mixing) as Ground Truths for determining the separated sound sources. Hence in the existing techniques, only synthetic mixtures are used to train the model for determining multiple sound sources. Thus, it may be advantageous to have a deep neural network trained using input labels which may include real-world sound signals rather than synthetic mixtures.

There is a need for a solution to overcome the above-mentioned drawbacks.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide a method and system for training sound source separation using Convolution Interpretation Maps and Visual Objects Mapping.

Additional aspects will be set forth in part in the description which follows and, in part, will be apparent from the description, or may be learned by practice of the presented embodiments.

In accordance with an aspect of the disclosure, a method for matching a visual source with a respective sound signal is provided. The method includes receiving a real-world sound input including a combination of one or more sound signals originating from a plurality of sound-generating objects. The method includes separating the one or more sound signals from the real-world sound input. The method includes detecting one or more sound generating objects included in the visual source. The method includes generating an association between each of the sound generating objects and the one or more separated sound signals, and matching in real-time, each of the detected sound generating objects with respective sound signals from the one or more separated sound signals based on the association.

In accordance with another aspect of the disclosure, a method for of processing a visual source is provided. The method includes receiving a preview of a visual source including a plurality of objects. The method includes detecting one or more sound generating objects from the plurality of objects in the visual source as a source of real-world sound, and displaying one or more controlling markers in a user-interface for controlling sound signals generated by each of the detecting sound generating objects, wherein each of the identified sound generating objects is mapped with the respective sound signals.

In accordance with another aspect of the disclosure, a method for training a neural network for matching a visual source with a respective sound signal is provided. The method includes receiving a real-world sound input including a combination of one or more sound signals originating from a plurality of sound generating objects. The method includes generating a spectrogram of the real-world sound input. The method includes processing the spectrogram to separate the sound signals based on identifying at least one class for each of the sound signals in the spectrogram, wherein the at least one class is indicative of a type of a sound generating object. The method includes computing a masking loss based on the separated sound signals. The method includes detecting one or more sound generating objects included in the visual source. The method includes generating an association between each of the sound generating objects and the separated sound signals based on a permutation invariant contrastive learning, and training the neural network to match each of the sound generating objects in the visual source with the respective sound signals from the separated sound signals based on the association.

In accordance with another aspect of the disclosure, a method for a sound source separation is provided. The method includes receiving, by a processor, a real-world sound input and an image, wherein the real-world sound input comprises a plurality of sound signals corresponding to a plurality of sound sources. The method includes processing the real-world sound input to detect the plurality of sound signals. The method includes performing separation of the identified plurality of sound signals to generate a plurality of separated sound signals. The method includes processing the image to detect a plurality of sound-generating objects in the image, and analyzing, in real time, the plurality of separated sound signals and the detected plurality of sound generating objects to match each sound-generating object with a respective separated sound source.

In accordance with another aspect of the disclosure, a system for matching a visual source with a respective sound signal is provided. The system includes a receiving module adapted to receive a real-world sound input including a combination of one or more sound signals originating from a plurality of sound-generating objects. The system includes a separating module adapted to separate the one or more sound signals from the real-world sound input. The system includes a detecting module adapted to detect one or more sound generating objects included in the visual source, and a generating module adapted to generate an association between each of the sound generating objects and the one or more separated sound signals, and matching in real-time, each of the detected sound generating objects with respective sound signals from the one or more separated sound signals based on the association.

In accordance with another aspect of the disclosure, a system of processing a visual source is provided. The system includes a receiving module adapted to receiving a preview of the visual source including a plurality of objects. The system includes a detecting module adapted to detect one or more sound generating objects from the plurality of objects in the visual source as a source of real-world sound, and a displaying module displaying one or more controlling markers in a user-interface for controlling sound signals generated by each of the identified sound generating objects, wherein each of the identified sound generating objects is mapped with the respective sound signals.

In accordance with another aspect of the disclosure, a system for training a neural network for matching a visual source with a respective sound signal is provided. The system includes a receiving module adapted to receive a real-world sound input including a combination of one or more sound signals originating from a plurality of sound generating objects. The system includes a separating module adapted to generate a spectrogram of the real-world sound input, process the spectrogram to separate the sound signals based on identifying at least one class for each of the sound signals in the spectrogram, wherein the at least one class is indicative of a type of a sound generating object, compute a masking loss based on the separated sound signals. The system includes a detecting module adapted to detect one or more sound generating objects included in the visual source. The system includes a generating module adapted to generate an association between each of the sound generating objects and the separated sound signals based on a permutation invariant contrastive learning, and a training module adapted to train the neural network to match each of the sound generating objects in the visual source with the respective sound signals from the separated sound signals based on the association.

In accordance with another aspect of the disclosure, a system for a sound source separation is provided. The system includes a receiving module adapted to receive a real-world sound input and an image, wherein the real-world sound input comprises a plurality of sound signals corresponding to a plurality of sound sources. The system includes a detecting module adapted to process the real-world sound input to detect the plurality of sound signals and a plurality of sound-generating objects in the image. The system includes a separation module adapted to perform separation of the identified plurality of sound signals to generate a plurality of separated sound signals, and a generating module adapted to analyze and generate, in real time, the plurality of separated sound signals and the detected plurality of sound generating objects to match each sound-generating object with a respective separated sound source.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 illustrates a block diagram depicting an environment of implementation of a system for matching a visual source with a sound signal, according to an embodiment of the disclosure;

FIG. 2 illustrates a block diagram of the system for matching the visual source with the sound signal, according to an embodiment of the disclosure;

FIG. 3 illustrates a block diagram of a controller of the system for matching the visual source with respective sound signal, according to an embodiment of the disclosure;

FIG. 4 illustrates a detailed neural network 309 for matching the visual source with the respective sound signal, according to an embodiment of the disclosure;

FIG. 5 illustrates a process flow of the multi label classifier to separate the sound signal, according to an embodiment of the disclosure;

FIG. 6 illustrates a flowchart depicting a method for matching the visual source with the sound signal, according to an embodiment of the disclosure; and

FIG. 7 illustrates a use-case for matching the visual source with the sound signal, according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect,” “another aspect” or similar language means that a particular feature, structure, or characteristic described in connection with the embodiment is included in at least one embodiment of the disclosure. Thus, appearances of the phrase “in an embodiment,” “in another embodiment” and similar language throughout this specification may, but do not necessarily, all refer to the same embodiment.

The terms “comprises,” “comprising,” or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

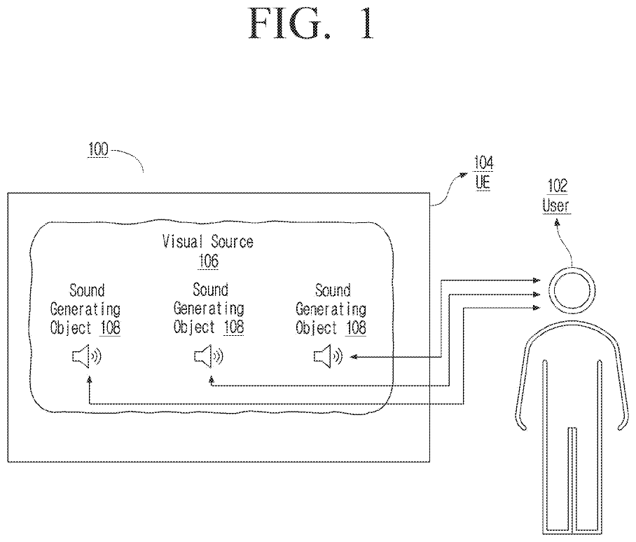

FIG. 1 illustrates a block diagram depicting an environment 100 of implementation for matching a visual source with a sound signal, according to an embodiment of the disclosure.

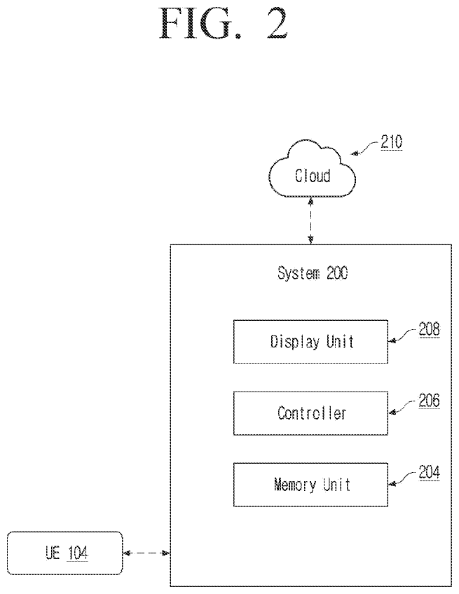

FIG. 2 illustrates a block diagram of the system 200 for matching the visual source with the sound signal according to an embodiment of the disclosure. For the sake of brevity, the system 200 for matching the visual source with the sound signal is hereinafter interchangeably referred to as the system 200. In an embodiment of the disclosure, the system 200 is connected with a cloud 210, for example, for storing details relating to the matching the visual source.

Referring to FIGS. 1 and 2, the system 200 may be implemented between a user 102 operating the user equipment (UE) 104. In an example, the UE 104 may include a tablet personal computer (PC), a Personal Digital Assistant (PDA), a mobile-device, a palmtop computer, a laptop computer, a desktop computer, a server, a cloud server, a remote server, a communications device, or any other machine controllable through the wireless-network and capable of executing a set of instructions (sequential or otherwise) that specify actions to be taken by that machine.

In an embodiment of the disclosure, the UE 104 displays the visual source 106 on a display screen of the UE 104. In an example, the visual source 106 may include a camera preview, a video, an image, exhibiting a sound generating object 108. In the example, the sound generating object 108 may produce sound which may be transmitted to the user 102. For instance, in the visual source 106, a human being speaking, a machine operating, a background music may be representative of the sound generating object 108. Thus, the video, the image may typically include multiple sound generating objects 108 and the user 102 may receive a sound signal mixed with sounds of all the sound generating object 108. Thus, the user 102 while viewing the visual source 106 may continuously receive a combination of sound signals originating from the sound generating object 108.

In an embodiment, the user 102 may be able to interact with the UE 104 to increase or decrease a magnitude of the sound signal of each of the sound generating object 108 present in the visual source 106. In an example, the system 200 matches the sound generating object 108 with the respective sound signal in real-time such that the user 102 may modify the magnitude of sound signal, i.e., volume for each of the sound generating object 108 in the visual source 106.

In an embodiment, the system 200 may reside in the UE 104. The system 200 may include a memory unit 204 adapted to store any data relating to operation of the system 200. The memory unit 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. In an embodiment, the system 200 may include a controller 206 in communication with the display unit 208 and the memory unit 204.

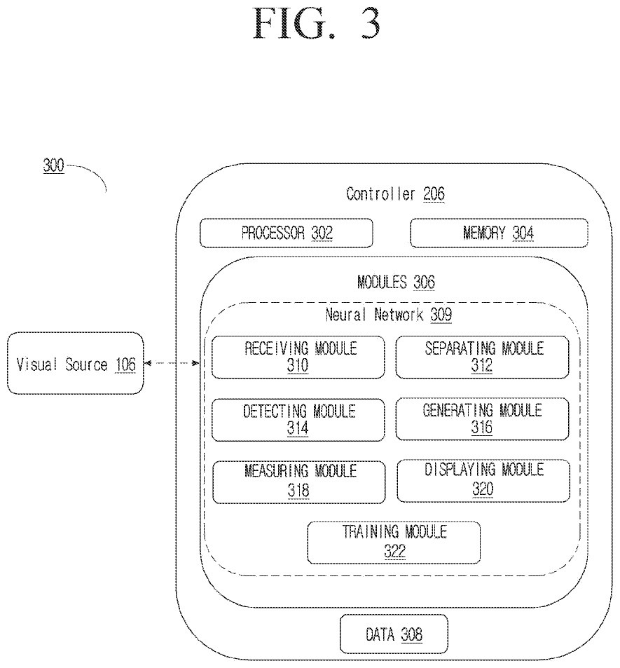

FIG. 3 illustrates a block diagram 300 of the controller 206 of the system 200 for matching the visual source 106 with the sound signal, according to an embodiment of the disclosure. The controller 206 may include, but is not limited to, a processor 302, memory 304, modules 306, and data 308. The modules 306 and the memory 304 may be coupled to the processor 302.

The processor 302 can be a single processing unit or several units, all of which could include multiple computing units. The processor 302 may be implemented as one or more microprocessors, microcomputers, microcontrollers, digital signal processors, central processing units, state machines, logic circuitries, and/or any devices that manipulate signals based on operational instructions. Among other capabilities, the processor 302 is adapted to fetch and execute computer-readable instructions and data stored in the memory 304.

The memory 304 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The modules 306, amongst other things, include routines, programs, objects, components, data structures, etc., which perform particular tasks or implement data types. The modules 306 may also be implemented as, signal processor(s), state machine(s), logic circuitries, and/or any other device or component that manipulate signals based on operational instructions.

Further, the modules 306 can be implemented in hardware, instructions executed by a processing unit, or by a combination thereof. The processing unit can comprise a computer, a processor, such as the processor 302, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the disclosure, the modules 306 may be machine-readable instructions (software) which, when executed by a processor/processing unit, perform any of the described functionalities.

In an embodiment, the modules 306 may include a supervised trained neural network 309. The modules 306 may include a receiving module 310, a separating module 312, a detecting (or detection) module 314, a generating module 316, a measuring module 318, a displaying module 320, and a training module 322. The receiving module 310, the separating module 312, the detecting module 314, the generating module 316, the measuring module 318, the displaying module 320, and the training module 322 may be in communication with each other. The data 308 serves, amongst other things, as a repository for storing data processed, received, and generated by one or more of the modules 306.

Referring to FIGS. 1, 2, and 3, the receiving module 310 may be adapted to receive a real-world sound input. In an example, the real-world sound input may be a combination of sound signals originating from the sound generating object 108, present in the visual source 106. As the UE 104, play the visual source 106, sound generating object 108 present in the visual source 106 produces sound signals. The sound signals from each of the sound generating object 108 in the visual source 106 combines to form the real-world sound input. In the example, the visual source 106 may include a live video, an image, or a preview of the video. The receiving module 310 is in communication with the separating module 312.

In an embodiment, the separating module 312 may be adapted to separate the sound signal from the real-world sound input. In an example, the separating module 312 may include an encoder 404 for generating a spectrogram. For instance, the encoder 404 may generate a Mel spectrogram from the real-world sound input. In the embodiment, the separating module 312 identifies a class for each of the sound signal in the spectrogram and train the neural network 309 for matching the visual source 106 with the sound signal.

In an example, the separating module 312 may be adapted to identify the class from the sound signals separated from the real-world sound input. In the example, the class is indicative of a type of the sound generating object 108. The classes may also be predefined, i.e., the neural network 309 may include the classes equivalent to the sound generating object 108. The separating module 312 may be adapted to split the spectrogram into ‘n’ number of horizontal patches. For instance, the ‘n’ number of horizontal patches may be equivalent to number of classes corresponding to ‘n’ number of sound signals which may be present in the real-world sound input. In the example, the neural network 309 may be trained to split the spectrogram based on the classes predefined in the neural network 309. The separating module 312 may be adapted to extract a feature from the horizontal patches of the spectrogram. Further, the features are concatenated, and the weights are determined from the concatenated features. The separating module 312 may be adapted to identify the sound signal corresponding to the classes which are predefined in the neural network 309 based on the determined weights.

Further, as the classes are identified for the separated sound signal, heat maps are generated for each of the class identified corresponding to the sound signal. In the example, class-activation mapping may be used for generating the heat map. The sound signals are then separated based on the heat map. Thus, the separating module 312 may separate each of the respective sound signals from the real-world sound input associated with the visual source 106. The receiving module 310, and the separating module 312 may be in communication with the detecting module 314.

In an embodiment, the detecting module 314 may be adapted to detect the sound generating object 108 included in the visual source 106. In an example, the sound generating object 108 is determined using an object detection technique. The sound generating object 108 determined by the detecting module 314 may represent source of real-world sound. The receiving module 310, the separating module 312, and the detecting module 314 may be in communication with the generating module 316.

In an embodiment, the generating module 316 may be adapted to generate an association between each of the sound generating object 108 detected by the detecting module 314 and the separated sound signals. In an example, the association between each of the sound generating object 108 and the separated sound signals is generated based on a contrastive learning technique. For instance, a permutation invariant contrastive learning is used to generate the association between sound generating object 108 and the separated sound signals.

Further, the generating module 316 may be adapted to match in real-time, each of the detected sound generating object 108 with a respective sound signal from the separated sound signals based on the association. The receiving module 310, the separating module 312, the detecting module 314, and the generating module 316 may be in communication with the measuring module 318.

In an embodiment, the measuring module 318 may be adapted to measure a magnitude of the sound signals after separating each of the respective sound signals from the real-world sound input associated with the visual source 106. The sound signals are mapped to the each of the sound generating object 108 in the visual source 106 and the magnitude may indicate the loudness of the sound signal being transmitted to the user 102. The measuring module 318 may be adapted to indicate the magnitude of each of the respective sound signals using sliding knobs. In an example, the sliding knobs may be indicative or represented by a controlling marker configured to be modified by the user for controlling the loudness of the sound signal being transmitted to the user 102. Thus, for instance the measuring module 318 may be adapted to receive a controlling input from the user 102 to vary a position of the sliding knob to one of increase or decrease the magnitude of the sound signal of the respective sound generating object 108 associated with the sliding knob. The receiving module 310, the separating module 312, the detecting module 314, the generating module 316, and the measuring module 318 may be in communication with the displaying module 320.

In an embodiment, the displaying module 320 may be configured to display the controlling markers on a user-interface (UI) of the UE 104 for controlling sound signals generated by each of the identified sound generating objects 108. In an example, the controlling markers as the sliding knob are displayed on the UI of the UE 104 such that the user 102 identifies each of the sliding knob corresponding to the sound generation object 108. In the example, each of the identified sound generating objects 108 remains mapped with the respective sound signals in accordance with the above disclosure. Thus, the user 102 may easily operate the sliding knob for controlling the sound signal output from the visual source 106 of various sound generating object 108. The receiving module 310, the separating module 312, the detecting module 314, the generating module 316, the measuring module 318 and the displaying module 320 may be in communication with the training module 322.

In an embodiment, the training module 322 may be configured to train the neural network 309 to match each of the sound generating object 108 in the visual source 106 with the respective sound signals from the separated sound signals based on the association. In an example, the neural network 309 may be trained in supervised learning technique with a labeled training set and is not limited to using only the real-world sound input or any source waveform for training. In the example, the labeled training set may be indicative of the identified classes or the pre-defined classes. The following paragraphs illustrates run-time and training of the neural network 309 for matching the visual source 106 with the respective sound signal.

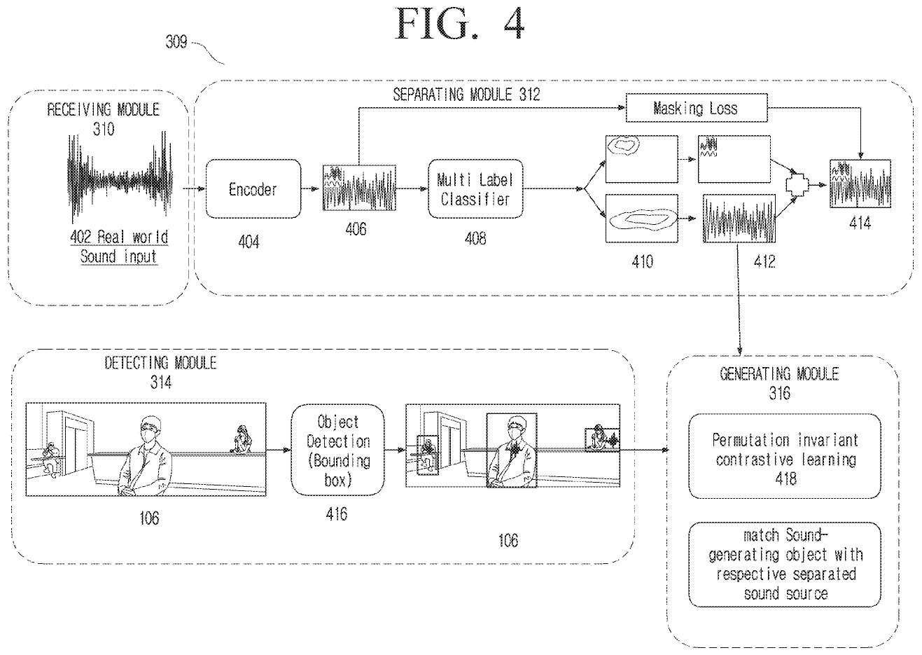

FIG. 4 illustrates a detailed neural network 309 for matching the visual source 106 with the respective sound signal, according to an embodiment of the disclosure.

In an embodiment, the neural network 309 includes a training phase using the labeled training set for matching the visual source 106 with the respective sound signal. The labeled training set is a ground truth or an output label for training the neural network 309. The labeled training set includes identifying the class of the sound signal as a label. Thus, the labels associate the class with the sound generating object 108. For example, the labeled training set may include a sound signal of rain, a sound signal of animal and a sound signal vehicle. The labels created in such labeled training set may indicate the class each for the sound signal of rain, the sound signal of animal and the sound signal of vehicle.

The receiving module 310 may be receiving the real-world sound input 402. In an example, the real-world sound input 402 may be used as the labeled training set adapted to train the neural network 309 to identify the classes for the sound signals. Providing the real-world sound input 402 as the labeled training set for training the neural network 309 enables supervised learning. The neural network 309 instead of receiving source waveform for training, receives the labeled training set which provide the classes identified for sound signals. The real-world sound input 402 may include the combination of sound signals originating from the sound generating objects 108 of the real-world.

The separating module 312 of the neural network 309 may include the encoder 404 to receive the real-world sound input 402 and generate the spectrogram 406. The spectrogram 406 is then subjected to the multi-class (or multi label) classifier 408. The multi-class classifier 408 is adapted to classify the spectrogram 406 for performing source classification. As the spectrogram 406 may include multiple sound signals, the multi-class classifier 408 typically includes a predefined class corresponding to the sound signals. The predefined class is created as result of training the neural network 309 with the labeled training set. Thus, predefined class is equivalent to the class present in the labeled training set. Thus, the multi-class classifier 408 identify the class for each of the sound signals in the spectrogram 406. The class identified for the sound signal is indicative of type of the sound generating object 108.

Further, upon identification of the classes for the sound signal, the heat map 410 may be generated using the Class Activation Mapping (CAM) technique. The separation module 312 uses the heat map 410 to separate the sound signal 412. A masking loss 414 may also be computed based on the separated sound signal 412.

In another embodiment, the detection module 314 may be adapted to receive the visual source 106. The detection module 314 may be adapted to apply the object detection bounding box 416 technique to mark a box area around each of the sound generating object 108 in the visual source 106.

The generating module 316 may be adapted to generate the association between each of the sound generating object 108 detected by the object detection bounding box 416 and the separated sound signals 412. The association is generated using the permutation invariant contrastive learning 418. Further, the generating module 316 may be adapted to match in real-time, each of the detected sound generating object 108 with respective sound signals from the separated sound signals 412 based on results of the permutation invariant contrastive learning 418.

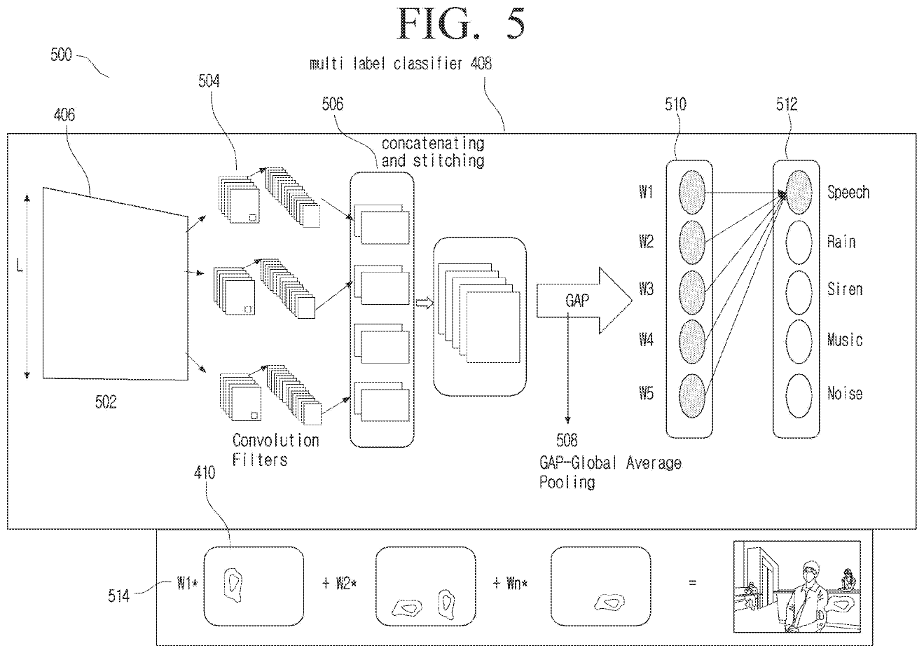

FIG. 5 illustrates a process flow 500 of the multi label classifier 408 to separate the sound signal, according to an embodiment of the disclosure.

At block 502, the process flow 500 may include splitting the spectrogram 406 into the horizontal patches. For instance, the spectrogram 406 may be split into ‘n’ number of patches equivalent to the number pre-defined classes in the multi label classifier 408. In an example, the length of each of the ‘n’ number of horizontal patches may be learned in accordance with the training, i.e., backpropagation to achieve maximum accuracy for the multi label classifier 408.

At block 504, the process flow 500 may include sending the ‘n’ number of horizontal patches into a convolutional layer for extracting features.

At block 506, the process flow 500 may include concatenating and stitching the extracted features together.

At block 508, the process flow 500 may include sending the concatenated extracted features from the convolutional layer to a Global Average Pooling (GAP) layer for determining weights corresponding to the features extracted.

At block 510, the process flow 500 may include the determined weights for source classification.

At block 512, the process flow 500 may include a final layer of the multi label classifier 408 for source classification or for identifying the class for each of the sound signal in the spectrogram 406. Thus, the neural network 309 is trained for identifying the class for each of the sound signals in the spectrogram 406.

At block 514, the process flow 500 may include generating the heat map 410 using the CAM technique and the equation as illustrated.

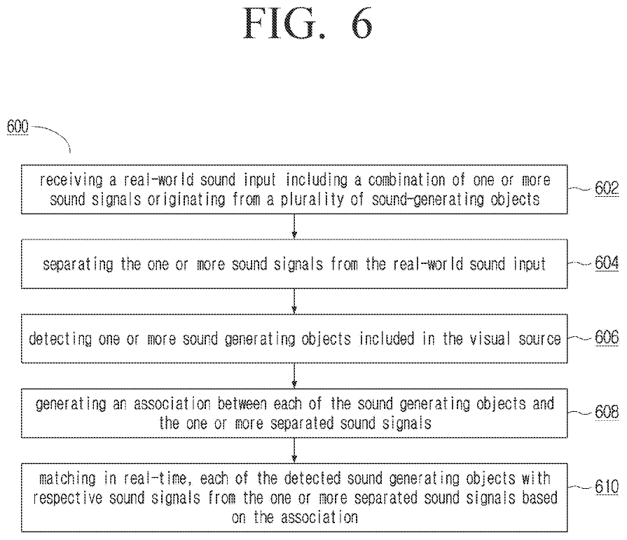

FIG. 6 illustrates a flowchart depicting a method 600 for matching the visual source 106 with the sound signal, according to an embodiment of the disclosure. The method 600 may be a computer-implemented method executed, for example, by the controller 206. For the sake of brevity, constructional and operational features of the system 200 that are already explained in the description of FIGS. 1, 2, 3, 4, and 5 are not explained in detail in the description of FIG. 6.

At operation 602, the method 600 may include receiving the real-world sound input. In an example, including a combination of sound signals originating from the sound-generating object 108. In the example, the real-world sound input corresponds to the visual source indicative of a camera-preview.

At operation 604, the method 600 may include separating the sound signals from the real-world sound input. In an example, for separating the sound signals, the method 600 may include generating the spectrogram 406 of the real-world sound input. The method 600 may include identifying the class for each of the sound signals in the spectrogram 406. In an example, the class is indicative of a type of the sound generating object 108. The method 600 may include splitting the spectrogram into ‘n’ number of horizontal patches based on a plurality of predefined classes. The neural network is trainable for splitting the spectrogram based on the predefined classes. Further, the features are extracted from the plurality of horizontal patches and concatenated. The method 600 may include determining weights from the concatenated features and identifying the separated sound signals 412 corresponding to the predefined classes based on the determined weights.

The method 600 may include generating the heat map 410 for the class identified and determining the separated sound signals 412 based on the heat map 410.

At operation 606, the method 600 may include detecting the sound generating object 108 included in the visual source 106. In an example, detecting the sound generating object 108 is based on the object detection technique.

At operation 608, the method 600 may include generating an association between each of the sound generating object 108 and the separated sound signals 412. In an example, the association is generated based on contrastive learning and wherein the contrastive learning is based on the permutation invariant contrastive learning.

At operation 610, the method 600 may include matching in real-time, each of the detected sound generating object 108 with the respective sound signals from the separated sound signals 412 based on the association generated.

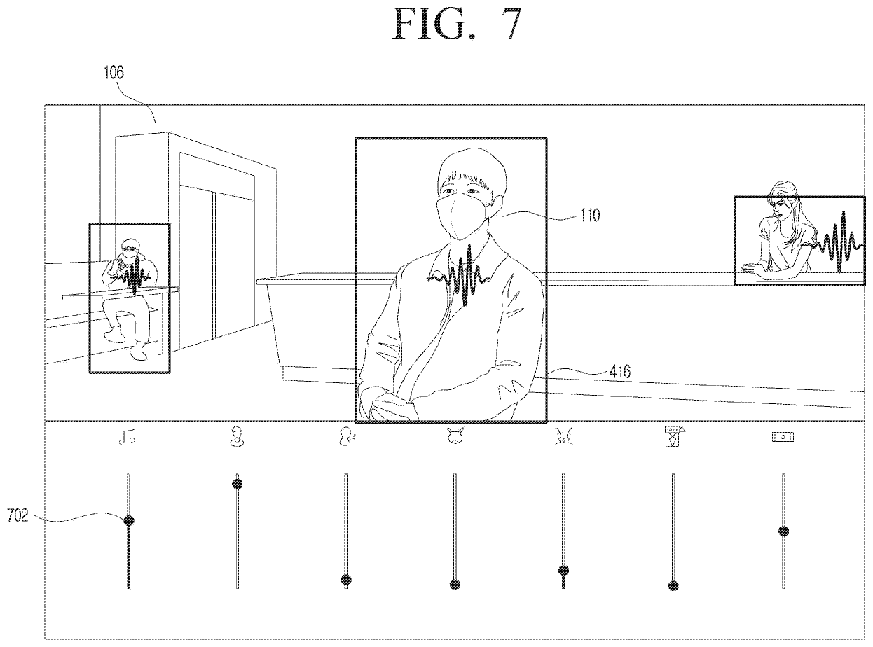

FIG. 7 illustrates a use-case for matching the visual source 106 with the sound signal, according to an embodiment of the disclosure.

The visual source 106 is illustrated. The sound generating object 108 are marked by the bounding box using the object detection bounding box 416. The user 102 may control the sliding knobs 702 to increase or decrease the magnitude of the each of the respective sound signals corresponding to the sound generating object 108 in the visual source 106.

The disclosure has following advantages:

The disclosure discloses supervised training of deep neural networks using real-world sound instead of synthetic sound. Thus, the accuracy of the neural network to match the visual source with the respective sound signal is much better.

The disclosure discloses contrastive learning-based approach where objects within the same image/frame are treated different entity thereby increasing the efficiency to associate a sound with the object.

The disclosure provides enables the user to decrease the sound generating from other unwanted sources in the video/image. The user may thus focus on the sound from the essential element in the video/image.

While specific language has been used to describe the disclosure, any limitations arising on account of the same are not intended. As would be apparent to a person in the art, various working modifications may be made to the method in order to implement the inventive concept as taught herein.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for matching a visual source with a respective sound signal, the method comprising:
receiving a real-world sound input including a combination of one or more sound signals originating from a plurality of sound-generating objects;
separating the one or more sound signals of the real-world sound input;
detecting one or more sound generating objects included in the visual source;
generating an association between each of the sound generating objects and the one or more separated sound signals; and
matching, in real-time, each of the detected sound generating objects with a respective sound signal from the one or more separated sound signals based on the association.

2. The method of claim 1,
wherein generating the association between each of the sound generating objects and the one or more separated sound signals is based on contrastive learning, and
wherein the contrastive learning is based on a permutation invariant contrastive learning.

3. The method of claim 1, wherein the real-world sound input corresponds to the visual source indicative of a camera-preview.

4. The method of claim 1, wherein detecting the one or more sound generating objects is based on an object detection technique.

5. The method of claim 1, wherein separating the one or more sound signals comprises:
generating a spectrogram of the real-world sound input;
identifying at least one class for each of the sound signals in the spectrogram, wherein the at least one class is indicative of a type of a sound generating object;
generating a heat map for the at least one class; and
determining the separated sound signals based on the heat map.

6. The method of claim 5, wherein identifying the at least one class for the sound signals in the spectrogram, further comprises:
splitting the spectrogram into a plurality of horizontal patches based on a plurality of predefined classes, using a neural network trainable for splitting the spectrogram based on the plurality of predefined classes;
extracting a plurality of features from the plurality of horizontal patches;
concatenating the plurality of features;
determining weights from the concatenated plurality of features; and
identifying the separated sound signals corresponding to the predefined classes based on the determined weights.

7. The method of claim 5, wherein the heat map is generated using a Class Activation Mapping (CAM) technique.

8. The method of claim 1, further comprising computing a masking loss based on the separated sound signals.

9. A method of processing a visual source (106), the method comprising:
receiving a preview of the visual source including a plurality of objects;
detecting one or more sound generating objects from the plurality of objects in the visual source as a source of real-world sound; and
displaying one or more controlling markers in a user-interface for controlling sound signals generated by each of the detected sound generating objects,
wherein each of the identified sound generating objects is mapped to a respective sound signal.

10. The method of claim 9, further comprising:
measuring a magnitude of each of the respective sound signals mapped to each of the sound generating objects in the preview, upon separating each of the respective sound signals from a real-world sound input associated with the preview;
indicating the magnitude of each of the respective sound signals using one or more user interface controls, wherein the one or more user interface controls correspond to the one or more controlling markers; and
receiving a controlling input from a user to vary a position of at least one user interface control of the one or more user interface controls to one of increase or decrease the magnitude of a sound signal of the respective sound generating object associated with the at least one user interface control.

11. A system for matching a visual source with a respective sound signal, the system comprising:
a receiving module configured to receive a real-world sound input including a combination of one or more sound signals originating from a plurality of sound-generating objects;
a separating module configured to separate the one or more sound signals of the real-world sound input;
a detecting module configured to detect one or more sound generating objects included in the visual source; and
a generating module configured to:
generate an association between each of the sound generating objects and the one or more separated sound signals, and
match, in real-time, each of the detected sound generating objects with a respective sound signal from the one or more separated sound signals based on the association.

12. The system of claim 11,
wherein the generating module is further configured to:
generate the association between each of the sound generating objects and the one or more separated sound signals based on contrastive learning, and
wherein the contrastive learning is based on a permutation invariant contrastive learning.

13. The system of claim 11, wherein the real-world sound input corresponds to the visual source indicative of a camera-preview.

14. The system of claim 11, wherein the detecting module is further configured to detect the one or more sound generating objects based on an object detection technique.

15. The system of claim 14, wherein the detecting module is further configured to apply an object detection bounding box technique to mark a box area around each sound generating object in the visual source.

16. The system of claim 11, wherein the separating module is further configured to separate the one or more sound signals by:
generating a spectrogram of the real-world sound input,
identifying at least one class for each of the sound signals in the spectrogram, wherein the at least one class is indicative of a type of a sound generating object,
generating a heat map for the at least one class, and
determining the separated sound signals based on the generated heat map.

17. The system of claim 16, wherein the separating module is further configured to identify the at least one class for the sound signals in the spectrogram by:
splitting the spectrogram into a plurality of horizontal patches based on a plurality of predefined classes, wherein a neural network is trainable for splitting the spectrogram based on the plurality of predefined classes;
extracting a plurality of features from the plurality of horizontal patches;
concatenating the plurality of features;
determining weights from the concatenated plurality of features; and
identifying the separated sound signals corresponding to the predefined classes based on the determined weights.

18. The system of claim 17, wherein the neural network is trained in a supervised learning technique with a labeled training set.

19. The system of claim 18, wherein the labeled training set is indicative of the predefined classes.
